(19) United States
(12) Patent Application Publication
(10) Pub. No.: US 2025/0046992 A1
(43) Pub. Date: Feb. 6, 2025

(54) SPLIT-SECTOR MULTIBAND ANTENNA HAVING A HYBRID TILT MECHANISM

(71) Applicant: JOHN MEZZALINGUA ASSOCIATES, LLC., Liverpool, NY (US)

(72) Inventors: Taehee Jang, Allen, TX (US); Niranjan Sundararajan, Clay, NY (US); Karthik Janardhanan, Syracuse,, NY (US)

(21) Appl. No.: 18/697,367

(22) PCT Filed: Feb. 9, 2024
(86) PCT No.: PCT/US24/15127

§ 371 Date: Mar. 29, 2024

Related U.S. Application Data
(60) Provisional application No. 63/484,313, filed on Feb. 10, 2023.

(51) Int. Cl. H01Q 3/06; H01Q 3/16

(52) U.S. Cl. CPC H01Q 3/06; H01Q 3/16

(57) ABSTRACT

A multi-band antenna has a first tilt section and a second tilt section. The first tilt section has a first tilted reflector on which is disposed a first plurality of radiators configured to radiate in a low band, and a first flat reflector on which is disposed a second plurality configured to radiate in a mid band; and a second tilt section having a second tilted reflector on which is disposed a third plurality of radiators configured to radiate in a low band, and a second flat reflector on which is disposed a fourth plurality configured to radiate in a mid band, the second tilted reflector being tilted at a second tilt angle. The antenna has a conformal radome that has sloped surfaces that substantially match the tilt of the first and second tilted reflectors.

### BACKGROUND OF THE INVENTION

Modern cellular communications require deployment of antennas that support multiple frequency bands: one or more higher frequency bands for higher bandwidth and data rates, and one or more lower frequency bands for robust coverage within structures and at greater coverage distances. Further, there is increasing demand for antenna sectorization whereby an antenna's capacity may be increased by dividing the antenna's coverage into multiple sectors. Antenna sectorization requires that an antenna be able to provide beams that can point in different directions in the azimuth plane.

In addition to the above performance demands, cellular antennas (macro antennas in particular) have strict requirements for wind loading. Macro cellular antennas must have a minimal cross-sectional profile to minimize its wind loading while mounted on top of a cell tower. This imposes constraints on the dimensions and design of the antenna's radome.

Conventional solutions for providing sectorization may involve refractive lenses or butler matrices for imposing amplitude and phase differentials for beamforming. These conventional solutions suffer deficiencies: first, reflractive lenses increase the volume and area of the antenna radome, exacerbating the wind loading problem; and in conventional beamforming the beam quality deteriorates and increasing steering angles due to reduction in gain and worsening of side lobes.

Accordingly, what is needed is a cellular antenna that is capable of providing high quality beam profiles in multiple directions while minimizing wind loading.

### SUMMARY OF THE INVENTION

An aspect of the disclosure involves an antenna. The antenna comprises a first tilt section having a first tilted reflector on which is disposed a first plurality of dipoles configured to radiate in a first frequency band, and a first flat reflector on which is disposed a second plurality of dipoles configured to radiate in a second frequency band, the second frequency band being higher in frequency than the first frequency band, the first tilted reflector being tilted at a first tilt angle; and a second tilt section having a second tilted reflector on which is disposed a third plurality of dipoles configured to radiate in a first frequency band, and a second flat reflector on which is disposed a fourth plurality or dipoles configured to radiate in a second frequency band, the second tilted reflector being tilted at a second tilt angle.

### BRIEF DESCRIPTION OF DRAWINGS

FIG. 1A illustrates an exemplary split-sector antenna according to the disclosure.

FIG. 1B is another view of the exemplary split-sector antenna of FIG. 1A.

FIG. 1C is a top view of the exemplary split-sector antenna of FIG. 1A

FIG. 2A illustrates an end view of the interior structure of an exemplary split-sector antenna according to the disclosure.

FIG. 2B illustrates the interior structure of FIG. 2A but with a conformal radome in place.

FIG. 3A provides a top view an exemplary conformal radome according to the disclosure.

FIG. 3B provides a side view of exemplary conformal radome according to the disclosure.

FIG. 3C provides a cross sectional profile of a first shell portion and a second shell portion of the exemplary conformal radome of the disclosure.

FIG. 4A is a cross sectional view of one tilted reflector and flat reflector of an embodiment of the disclosed split-sector antenna having a 27 degree mechanical tilt.

FIG. 4B is a cross sectional view of one tilted reflector and flat reflector of the disclosed split-sector antenna having a 22 degree mechanical tilt and 5 degree electrical tilt.

FIG. 4C is a cross sectional view of one tilted reflector and flat reflector of the disclosed split-sector antenna having a 17 degree mechanical tilt and 10 degree electrical tilt.

### DETAILED DESCRIPTION OF THE INVENTION

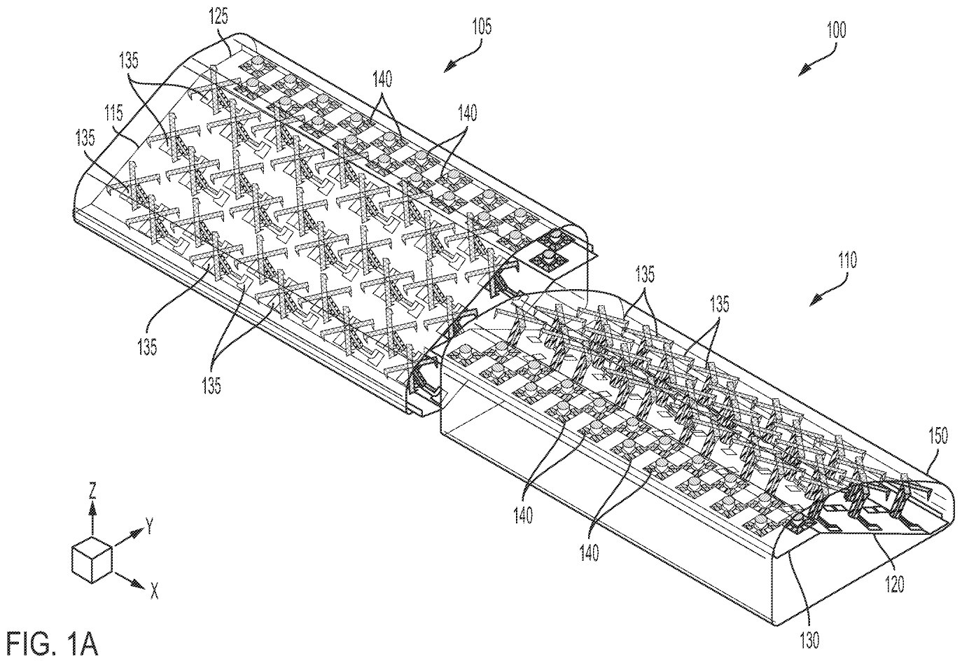

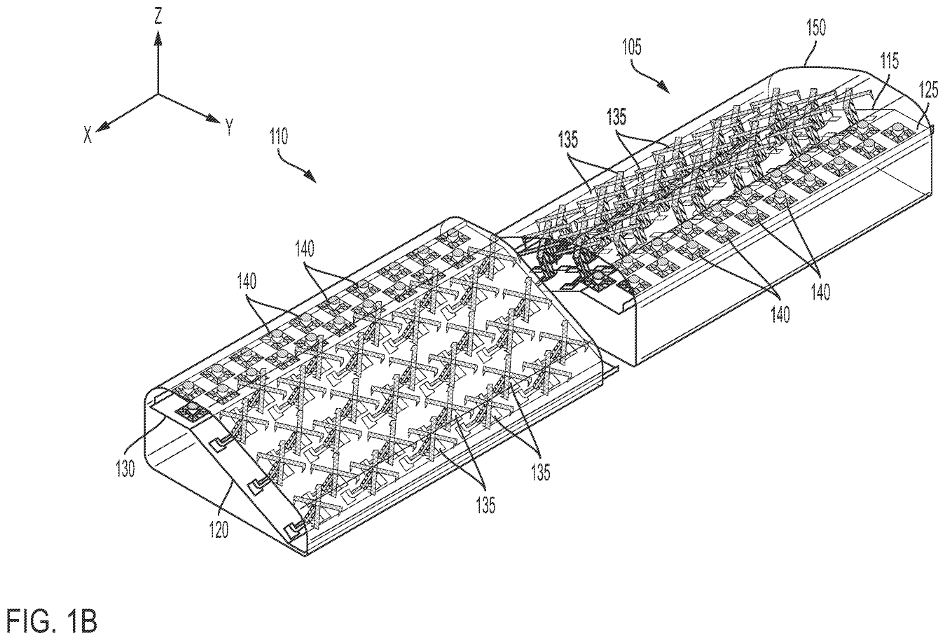

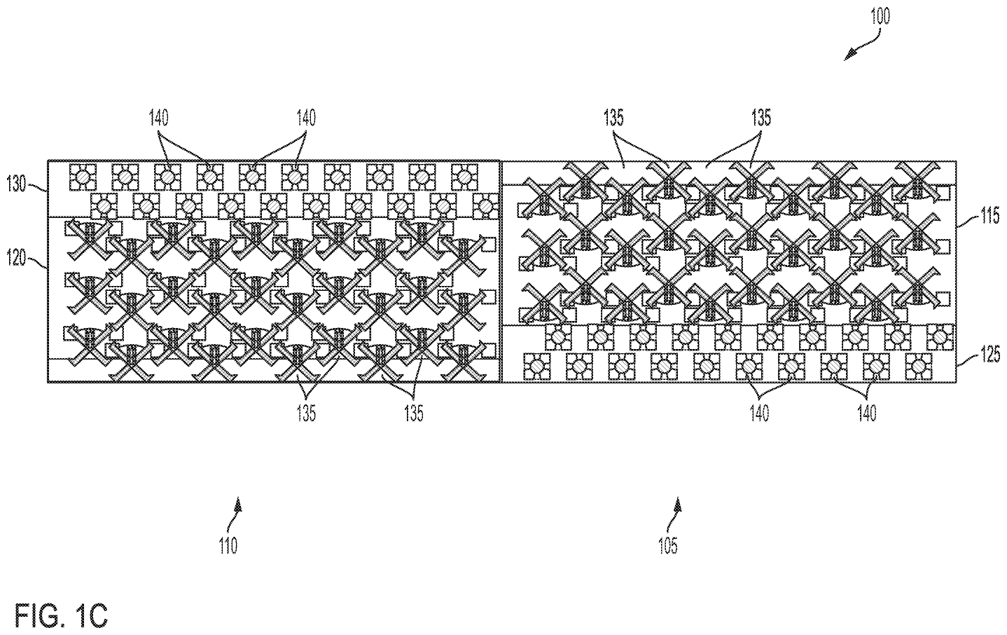

FIG. 1A illustrates an exemplary split-sector antenna 100 according to the disclosure. Exemplary split-sector antenna 100 has dipoles that radiate in two different frequency bands: low band (LB)(617-860 MHz), and mid band (MB)(1695-2690 MHz). Split-sector antenna 100 has a first tilt section 105 and a second tilt section 110. First tilt section 105 has a first tilted reflector 115 on which is disposed an array of LB dipoles 135, and a first flat reflector 125 on which is disposed an array of MB dipoles 140. Second tilt section 110 has a second tilted reflector 120 on which is disposed an array of LB dipoles 135, and a second flat reflector 130 on which is disposed an array of MB dipoles 140. First tilted reflector 115 and second tilted reflector 120 may have the same but opposite tilt angle. Shown in FIG. 1A is an x/y/z coordinate system, whereby the x-axis corresponds to the vertical axis and the azimuth plane is defined by the y-axis and z-axis. As illustrated, the tilt angle for first tilted reflector 115 and second tilted reflector 120 is around the x axis. Exemplary split-sector antenna 100 may have a conformal radome 150.

FIG. 1B is a rotated view of split-sector antenna 100.

FIG. 1C is a top view of split-sector antenna 100, along the negative direction of the z-axis.

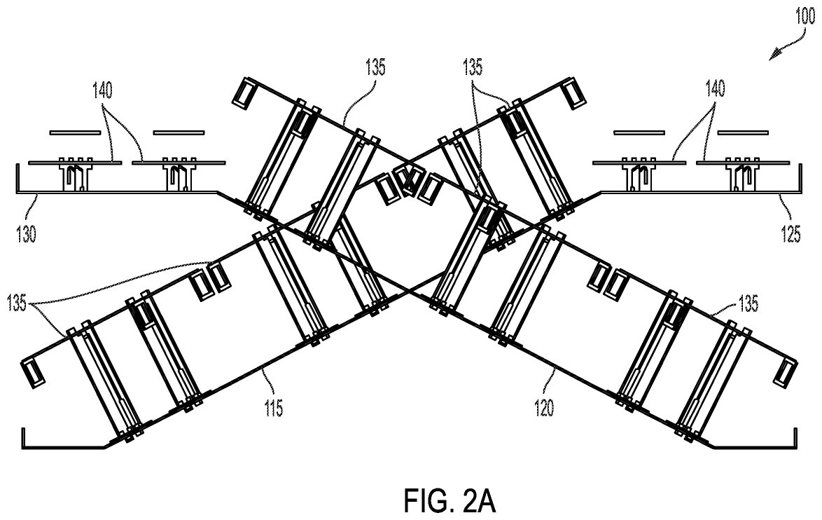

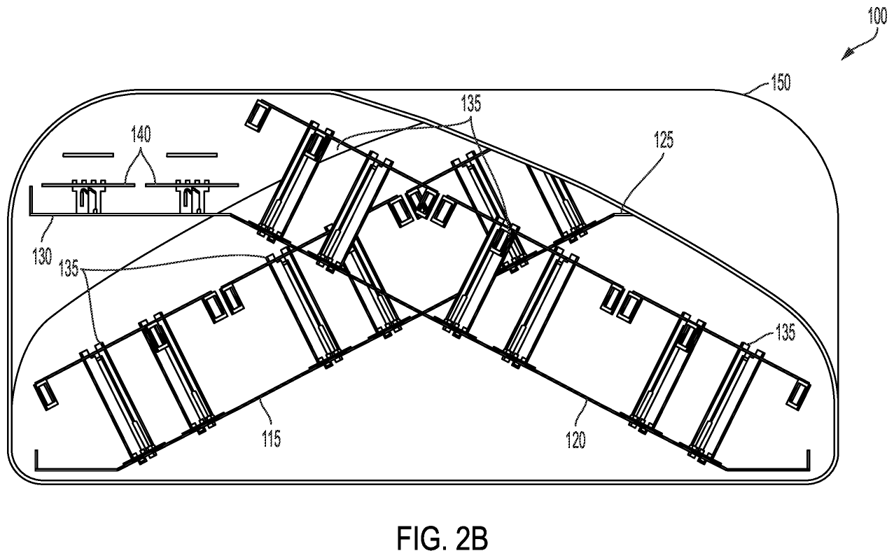

FIG. 2A illustrates an end view of the interior structure of split-sector antenna 100 with conformal radome 150 removed. This view is along the x-axis. Illustrated are first tilted reflector 115 on which are disposed an array of LB dipoles 135, wherein first tilted reflector 115 may be mechanically coupled to first flat reflector 125 on which are disposed an array of MB dipoles 140; and second tilted reflector 120 on which are disposed an array of LB dipoles 135, wherein second tilted reflector 120 may be mechanically coupled to second flat reflector 130 one which are disposed an array of MB dipoles 140.

FIG. 2B illustrates the structure of FIG. 2A but with conformal radome 150 in place.

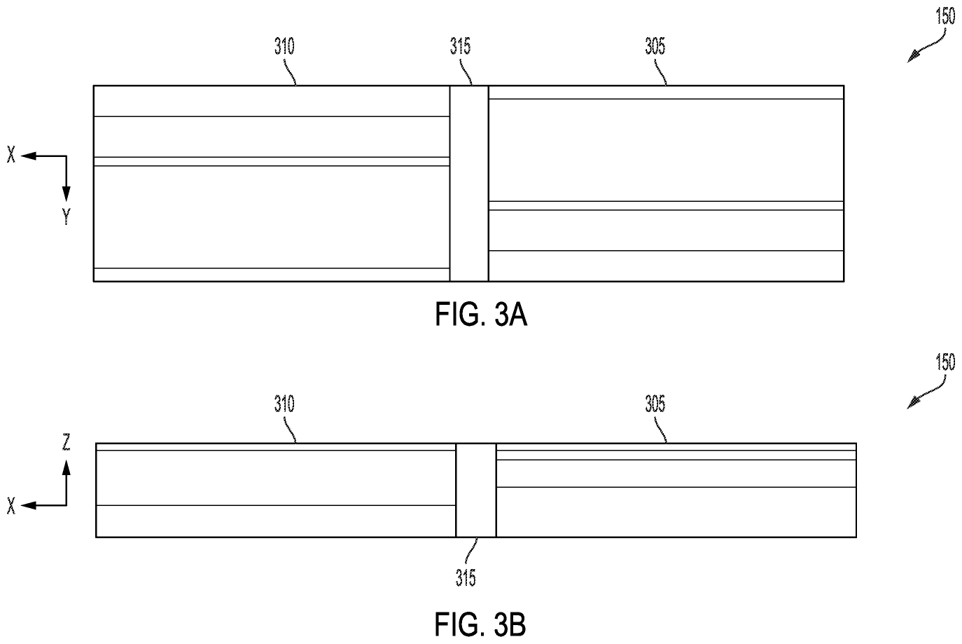

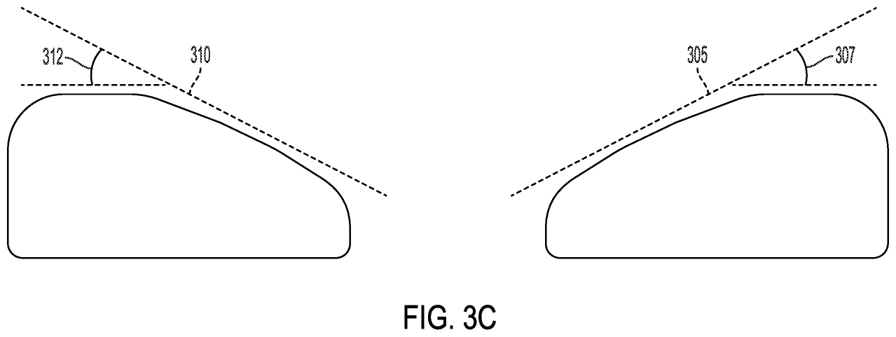

FIG. 3A is a top view of exemplary conformal radome 150, which is along the negative direction of the z-axis. Conformal radome 150 has a first shell portion 305, which covers first tilt section 105; a second shell portion 310, which covers second tilt section 110; and a transition segment 315 which provides a transitional contour between first shell portion 305 and second shell portion 310.

FIG. 3B is a side view of exemplary conformal radome 150, which is along the negative y-axis, showing first shell portion 305, second shell portion 310, and transition segment 315.

FIG. 3C illustrates exemplary cross-sectional profiles of first shell portion 305 and second shell portion 310. First shell portion 305 may have a sloped shape wherein the sloped shape has a slope angle 307 that may be substantially similar to the tilt angle of first tilted reflector 115. Similarly, second shell portion 310 may have a sloped shape that has a slope angle 312 that may be substantially similar to the tilt angle of second tilted reflector 120. As used herein, the sloped shape having a slope angle 307/312 that is substantially similar to the corresponding reflector tilt angle may mean that the sloped shape may have a curvature (and not a flat surface) and that the slope angle 307/312 may approximate an angle formed by the sloped shape.

The shape of conformal radome 150 may offer benefits in reduced wind loading due to the angled surfaces of first shell portion 305 and second shell portion 310.

The tilt angle of first tilted reflector 115 and second tilted reflector 120 provides an angular bias for pointing the beam formed by the respective arrays of LB dipoles 135 formed on first tilted reflector 115 and second tilted reflector 120. For each of first/second tilted reflector 115/120, optimal gain corresponds to a beam formed orthogonal to the respective reflector surface. In an exemplary embodiment according to the disclosure, the tilt angle of first tilted reflector 115 and second tilted reflector 120 may be such that this mechanical tilt is sufficient to provide two distinct beams for two separate sectors. For example, if the tilt angle of first tilted reflector 115 is +27 degrees and second tilted reflector 120 is −27 degrees, the respective gain patterns of first tilted reflector 115 and second tilted reflector 120 are separated by 54 degrees. That is, a direction normal to the first tilt reflector and a direction normal to the second tilt reflector are angularly separated in the azimuth plane by 54 degrees. This may be sufficient separation. However, having the tilt angles set at +/−27 degrees, increases the height of the antenna 100 and conformal radome 150 in the z-direction. If there are limits on the height of conformal radome 150 along the z-axis, then antenna 100 may be configured with a reduced tilt angle, thereby reducing the height of conformal radome 150. However, a reduced tilt angle with correspondingly reduce the azimuth plane angular separation of the beams (gain patterns) emitted by first tilted reflector 115 and second tilted reflector 120. In this case, to maintain azimuth plane angular separation, it is necessary to apply an electrical beam tilt to point the respective beams away from each other. This maintains the azimuth plane angular separation while reducing the height of conformal radome 150. As used herein, a hybrid tilt mechanism is a combination of mechanical tilt (tilt angle of first tilted reflector 115 and second tilted reflector 120) and an electrical tilt mechanism.

Having a set tilt angle substantially mitigates the beam quality degradation brought on by electrical tilt methods. According to electrical tilt methods, providing differential amplitude and phase weighting to the signals fed to the LB dipoles 135 may steer the beam emitted by the corresponding array of LB dipoles 135 in the azimuth plane (defined by the z-axis and y-axis). As the beam is steered, the antenna gain diminishes proportional to the angle according to a cos(0) relation, where 0 is the beam steer angle from the direction normal to the surface of the reflector. Accordingly, the beam degrades with increasing angle, not only by loss of gain but by increase in sidelobes.

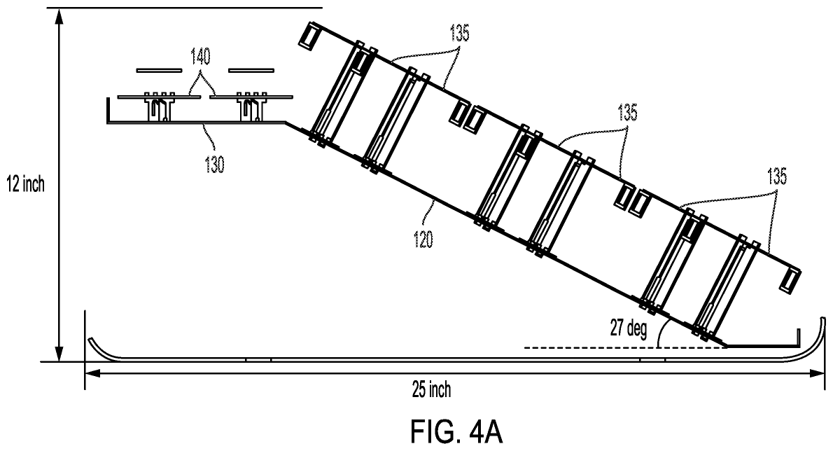

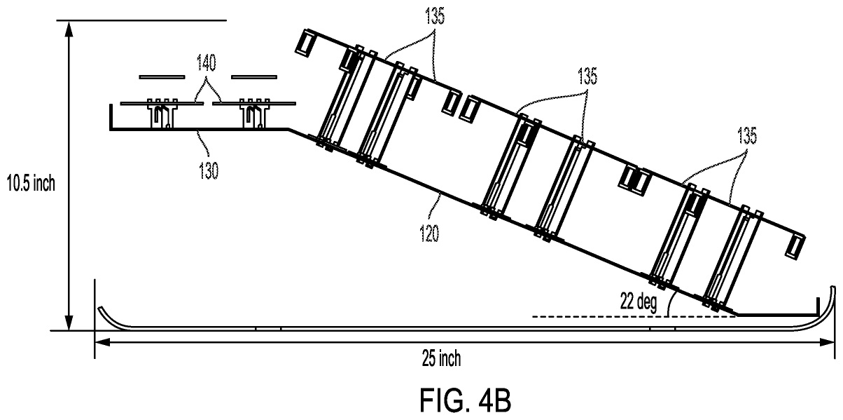

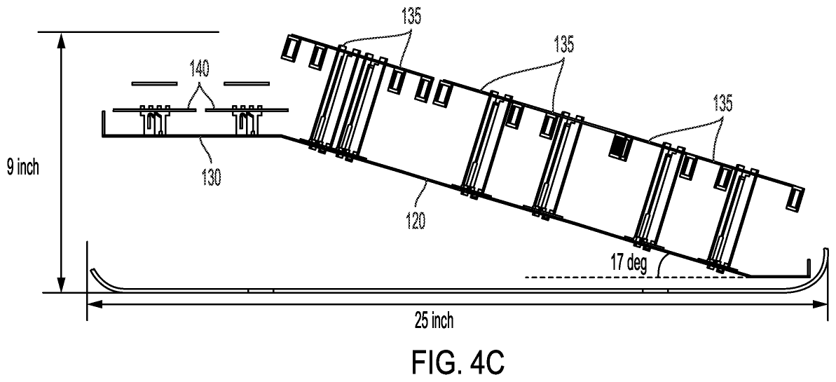

FIG. 4A is a cross sectional view of second tilted reflector 120 and second flat reflector 130 of an embodiment of the disclosed split-sector antenna having a 27 degree mechanical tilt, along with exemplary dimensions. In this example, first tilted reflector 115 and first flat reflector 125 may have the same but opposite tilt. They are omitted from the drawing for the purpose of simplifying the figure. As illustrated, second tilted reflector 120 has disposed on it an array of LB dipoles 135, and second flat reflector 130 may have disposed on it an array of MB dipoles 140. In this example, the two LB beams are thus biased at 27 degrees off normal (the z-axis), providing a 54 degree spread in the azimuth plane (defined by the x-axis and y-axis). In this exemplary embodiment, no electrical tilt would be required to maintain beam separation. Given a +/−27 degree tilt angle for first tilted reflector 115 and second tilted reflector 120, conformal radome 150 will need to extend 12 inches in direction along the z-axis.

In the exemplary embodiments disclosed, the arrays of LB dipoles 135 on first tilted reflector 115 and second tilted reflector 120 may provide a beamwidth of 33 degrees. However, it will be understood that variations to this beamwidth are possible and within the scope of the disclosure.

FIG. 4B is a cross sectional view of second tilted reflector 120 and second flat reflector 130 of an embodiment of the disclosed split-sector antenna having a 22 degree mechanical tilt, along with exemplary dimensions. As with the previous example, first tilted reflector 115 and first flat reflector 125 may have the same but opposite tilt. They are omitted from the drawing for the purpose of simplifying the figure. However, a direction normal to the first tilt reflector and a direction normal to the second tilt reflector are angularly separated in the azimuth plane by 44 degrees. As illustrated, second tilted reflector 120 has disposed on it an array of LB dipoles 135, and second flat reflector 130 may have disposed on it an array of MB dipoles 140. In this exemplary embodiment, in order to maintain +/−27 degree beam separation in the azimuth plane, it is necessary to apply electrical beam steering (via differential phase and amplitude weighting) to steer the beam an additional 5 degrees to the 22 degree tilt angle. In this case, the array of LB dipoles 135 disposed on first tilted reflector 115 will have additional phase shifter circuitry (not shown) to impart an additional +5 degrees of electrical tilt on top of the existing +22 degree tilt angle. Similarly, the array of LB dipoles 135 disposed on second tilted reflector 120 will have additional phase shifter circuitry (not shown) to impart an additional −5 degrees of electrical tilt on top of the existing −22 degree tilt angle. An advantage of this exemplary embodiment is that the height of conformal radome 150 is 10.5 inches along the z-axis.

FIG. 4C is a cross sectional view of second tilted reflector 120 and second flat reflector 130 of an embodiment of the disclosed split-sector antenna having a 17 degree mechanical tilt, along with exemplary dimensions. The LB array uses the partial array factor to provide 10 degree electrical tilt in order to make ±27 degree split sector antenna. As with the other two examples, first tilted reflector 115 and first flat reflector 125 may have the same but opposite tilt. They are omitted from the drawing for the purpose of simplifying the figure. However, a direction normal to the first tilt reflector and a direction normal to the second tilt reflector are angularly separated in the azimuth plane by 34 degrees. As illustrated, second tilted reflector 120 has disposed on it an array of LB dipoles 135, and second flat reflector 130 may have disposed on it an array of MB dipoles 140. In this exemplary embodiment, in order to maintain +/−27 degree beam separation in the azimuth plane, it is necessary to apply electrical beam steering (via differential phase and amplitude weighting) to steer the beam an additional 10 degrees to the 17 degree tilt angle. In this case, the array of LB dipoles 135 disposed on first tilted reflector 115 will have additional phase shifter circuitry (not shown) to impart an additional +10 degrees of electrical tilt on top of the existing +17 degree tilt angle. Similarly, the array of LB dipoles 135 disposed on second tilted reflector 120 will have additional phase shifter circuitry (not shown) to impart an additional −10 degrees of electrical tilt on top of the existing −17 degree tilt angle. An advantage of this exemplary embodiment is that the height of conformal radome 150 is 9 inches along the z-axis.

Variations to split-sector antenna 100 are possible. For example, dipoles of different frequency bands may be used: the LB dipoles 135 and MB dipoles 140 may be reversed such that the MB dipoles 140 are disposed on first tilted radiator 115 and second tilted radiator 120. Further, additional dipoles and dipole arrays, such as those that operate in the C-Band, may be present. Also, although a desired beam separation of 54 degrees is discussed above, it will be understood that other beam separations—and the resulting tilt angles—may be used. It will be understood that such variations are possible and within the scope of the disclosure.

1. An antenna, comprising:
a first tilt section having a first tilted reflector on which is disposed a first plurality of dipoles configured to radiate in a first frequency band, and a first flat reflector on which is disposed a second plurality of dipoles configured to radiate in a second frequency band, the second frequency band being higher in frequency than the first frequency band, the first tilted reflector being tilted at a first tilt angle relative to the first flat reflector; and
a second tilt section having a second tilted reflector on which is disposed a third plurality of dipoles configured to radiate in the first frequency band, and a second flat reflector on which is disposed a fourth plurality or dipoles configured to radiate in the second frequency band, the second tilted reflector being tilted at a second tilt angle relative to the second flat reflector,
wherein the first and second flat reflectors are oriented in the same direction in an azimuth plane.

2. The antenna of claim 1, wherein the second tilt angle is an opposite angle of the first tilt angle in the azimuth plane.

3. The antenna of claim 1, further comprising a conformal radome.

4. The antenna of claim 3, wherein the conformal radome comprises:
a first shell portion configured to cover the first tilt section;
a second shell portion configured to cover the second tilt section; and
a transition segment disposed between the first shell portion and the second shell portion.

5. The antenna of claim 4, wherein the first shell portion comprises a sloped shape having a first slope angle that is substantially similar to the first tilt angle.

6. The antenna of claim 5, wherein the second shell portion comprises a sloped shape having a second slope angle that is substantially similar to the second tilt angle.

7. The antenna of claim 1, wherein the first frequency band comprises a low band.

8. The antenna of claim 7, wherein the second frequency band comprises a mid band.

9. The antenna of claim 1,
wherein the first tilted reflector is mechanically coupled to the first flat reflector, and
wherein the second tilted reflector is mechanically coupled to the second flat reflector.

10. The antenna of claim 2, wherein the first tilt angle is 27 degrees and the second tilt angle is −27 degrees, such that there is a difference of 54 degrees between a direction normal to the first tilt reflector and a direction normal to the second tilt reflector.

11. The antenna of claim 2, wherein the first tilt angle is +22 degrees and the second tilt angle is −22 degrees, such that there is a difference of 44 degrees between a direction normal to the first tilt reflector and a direction normal to the second tilt reflector.

12. The antenna of claim 11, further comprising:
a first electrical tilt circuit coupled to the first plurality of dipoles, the first electrical tilt circuit configured configured to steer a first antenna beam generated by the first plurality of dipoles, so as to impart an additional +5 degrees of tilt angle to the first antenna beam; and
a second electrical tilt circuit coupled to the third plurality of dipoles, the second electrical tilt circuit configured to steer a second antenna beam generated by the second plurality of dipoles, so as to impart an additional −5 degrees of tilt angle to the second antenna beam.

13. The antenna of claim 12, wherein the conformal radome has a height of 10.5 inches.

14. The antenna of claim 2, wherein the first tilt angle is +17 degrees and the second tilt angle is −17 degrees, such that there is a difference of 34 degrees between a direction normal to the first tilt reflector and a direction normal to the second tilt reflector.

15. The antenna of claim 14, further comprising:
a first electrical tilt circuit coupled to the first plurality of dipoles, the first electrical tilt circuit configured to steer a first antenna beam generated by the first plurality of dipoles, so as to impart an additional +10 degrees of tilt angle to the first antenna beam; and
a second electrical tilt circuit coupled to the third plurality of dipoles, the second electrical tilt circuit configured to steer a second antenna beam generated by the second plurality of dipoles, so as to impart an additional −10 degrees of tilt angle to the second antenna beam.

16. The antenna of claim 15, wherein the conformal radome has a height of 9 inches.

17. An antenna, comprising:
a first section having a first reflector on which is disposed a first plurality of dipoles configured to radiate in a first frequency band, and a second reflector on which is disposed a second plurality of dipoles configured to radiate in a second frequency band, the second frequency band being higher in frequency than the first frequency band; and
a second section having a first reflector on which is disposed a third plurality of dipoles configured to radiate in the first frequency band, and a second reflector on which is disposed a fourth plurality or dipoles configured to radiate in the second frequency band,
wherein the first and second reflectors of the first section have orientations such that a direction normal to the first reflector of the first section and a direction normal to the second reflector of the first section are separated by a first tilt angle in an azimuth plane,
wherein the first and second reflectors of the second section have orientations such that a direction normal to the first reflector of the second section and a direction normal to the second reflector of the second section are separated by a second tilt angle, opposite the first tilt angle, in an azimuth plane, and
wherein the direction normal to the second reflector of the first section and the direction normal to the second reflector of the second section are the same direction.

18. The antenna of claim 17,
wherein the first and second reflectors of the first section are mechanically coupled to each other, and
wherein the first and second reflectors of the second section are mechanically coupled to each other.

19. The antenna of claim 17 further comprising:
a first electrical tilt circuit coupled to the first plurality of dipoles, the first electrical tilt circuit configured to steer a first antenna beam generated by the first plurality of dipoles, so as to impart a first additional tilt angle to the first antenna beam; and
a second electrical tilt circuit coupled to the third plurality of dipoles, the second electrical tilt circuit configured to steer a second antenna beam generated by the second plurality of dipoles, so as to impart a second additional tilt angle to the second antenna beam.

20. The antenna of claim 17 further comprising a conformal radome, wherein the conformal radome comprises:
a first shell portion configured to cover the first section,
a second shell portion configured to cover the second section, and
a transition segment disposed between the first shell portion and the second shell portion, and
wherein the first shell portion comprises a sloped shape having a first slope angle that is dependent on the first tilt angle, and the second shell portion comprises a sloped shape having a second slope angle that is dependent on the second tilt angle.
